(19) United States
(12) Patent Application Publication
(10) Pub. No.: US 2002/0054560 A1
(43) Pub. Date: May 9, 2002

(54) Transducer and method for reading and writing data from and to a medium

(75) Inventors: Zine Eddine Boutaghou, Vadnais Heights, MN (US); Wayne Allen Bonin, North Oaks, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Seagate Technology LLC

(21) Appl. No.: 10/008,230

(22) Filed: Nov. 7, 2001

Related U.S. Application Data
(60) Provisional application No. 60/247,666, filed on Nov. 9, 2000.

(51) Int. Cl. G11B 15/64; G11B 5/187; G11B 5/60; G11B 17/32; G11B 21/20; G11B 17/00; G11B 21/16; G11B 7/00

(52) U.S. Cl. 369/244; 360/234.7; 360/122; 369/300

(57) ABSTRACT

The present invention relates to a transducer that comprises a body and a tip extending from the body. The tip includes an exposed portion that has a consistent cross-sectional area. The present invention also relates to a method of translating data to or from a medium. The method comprises the steps of maneuvering a transducer that has an exposed tip with a consistent cross-sectional area to a particular location relative to the medium, and engaging the medium using the tip on the transducer. The transducer and method of the present invention reduce the effects of transducer wear. The optimum performance of the transducer is maintained because the consistent cross-sectional area of the tip ensures that the surface area on the end of the tip is preserved over the life of the transducer.

### RELATED APPLICATIONS

This application claims the benefit under 35 U.S.C. 119(e) of U.S. Provisional Application Ser. No. 60/247,666 filed Nov. 9, 2000.

### FIELD OF THE INVENTION

The present invention relates to the field of electronic devices that store data. More particularly, this invention relates to a transducer and method for translating data to and/or from a medium.

### BACKGROUND OF THE INVENTION

One of the key components of any computer system is a place to store data. Computer systems have many different places where data can be stored. One common place for storing massive amounts of data in a computer system is on a disc. The basic parts of any disc storage system are a disc that is rotated, an actuator that moves a transducer to various locations on or over the disc, and electrical circuitry that is used to write and read data to and from the disc. A typical disc storage system includes a microprocessor that controls most of the operations of the system. The microprocessor utilizes circuitry to encode data so that it can be successfully retrieved from and written to a medium on the disc.

The transducer is the operative device within the system that translates information representing data from/to the disc. Transducers are typically in the form of a slider which includes a separate read transducer and write transducer. The slider and transducers are sometimes referred to as a head. The heads are located on both sides of one or more discs. As a disc spins, the head is accurately positioned on or above the disc such that the head can store data onto the disc by writing data onto the disc. Similarly, reading data from a disc is accomplished by positioning the head on or above the appropriate location on the disc and reading the stored material from the disc.

There are several methods of storing data to a medium and retrieving data from a medium. Some of the known methods are magnetic, optic, magneto-optic recording. Depending on the method that is used to store and retrieve data, the transducer includes a tip that extends from the rest of the transducer. These types of exposed tips may be adapted to conduct thermal and/or electrical energy, and may also be used to create indentations in a medium, such as in the fabrication of a MEMS device.

FIG. 1 illustrates a prior art transducer 10. The transducer 10 includes a tip 11 that is mounted onto a conductor 12 which supplies thermal and/or electrical energy to the tip 11 depending on the application where the transducer 10 is being used. The tip 11 includes a cone 13 that has a point 14. The conductor 12 and the tip 11 are typically mounted onto a ceramic substrate 15.

There are several problems associated with the using the transducer 10 illustrated in FIG. 1. As shown in FIG. 2, the tip 11 of the transducer 10 tends to wear, especially in applications where the tip 11 engages the medium. As the tip 11 wears, the surface area on the point 14 of the cone 13 continually increases in size. Increasing the size of that portion of the tip 11 which engages, or is proximate to, the medium results in a drop in the transfer density that can be achieved by the transducer 10. A lower transfer density is undesirable because less data can be stored on the medium or fewer physical indentations may be made in the medium. The point 14 of the tip 11 is also subject to high stresses during operation of the transducer 10 such that the tip 11 is highly vulnerable to fracturing. Each of these problems results in a performance loss for the transducer 10.

There are also times when the transducer 10 inadvertently contacts the medium as the medium and/or transducer 10 are moving relative to one another at high speeds. An inadvertent contact between the transducer 10 and the medium is typically referred to as a crash. Crashes can cause many problems including the loss of data stored on the medium and catastrophic damage to the point 14 on the tip 11 of the transducer 10.

As a result there is a need for a transducer with an exposed tip that (i) is less sensitive to the wear; (ii) reduces the effect of inadvertent disc crashes; and (iii) has increased service life.

### SUMMARY OF THE INVENTION

The present invention relates to a transducer that comprises a body and a tip extending from the body. The tip includes an exposed portion that has a consistent cross-sectional area.

The present invention also relates to a method of translating data to or from a medium. The method comprises the steps of maneuvering a transducer that has an exposed tip with a consistent cross-sectional area to a particular location relative to the medium, and communicating with the medium using the tip on the transducer.

The transducer and method of the present invention reduce the effects of transducer wear. The optimum performance of the transducer is maintained because the consistent cross-sectional area of the tip ensures that the surface area on the end of the tip is preserved over the life of the transducer. The tip is also more likely to operate in an adequate manner even after there is in advertent contact between the transducer and the medium making the transducer less susceptible to crashes. Therefore, any system that utilizes the transducer and method of the present invention will be more reliable and have an extended service life.

### BRIEF DESCRIPTION OF THE DRAWINGS

FIG. 1 is a side view of a prior art transducer.

FIG. 2 is a side view similar to FIG. 1 illustrating the transducer shown in FIG. 1 after the transducer has been worn by use.

FIG. 3 is an exploded perspective of a disc drive that includes a transducer of the present invention.

FIG. 4 is a side view illustrating the transducer of the present invention.

FIG. 5 is a side view similar to FIG. 4 illustrating the transducer shown in FIG. 4 after the transducer has been worn by use.

FIG. 6 is a perspective view of the transducer shown in FIG. 4.

FIG. 7 is a section view of the transducer shown in FIG. 4 taken along line 7-

FIG. 8 is a section view similar to FIG. 7 illustrating another embodiment of a tip that is used in the transducer of the present invention.

FIG. 9 is a section view similar to FIG. 7 illustrating yet another embodiment of a tip that is used in the transducer of the present invention.

FIG. 10 is a section view similar to FIG. 7 illustrating yet another embodiment of a tip that is used in the transducer of the present invention.

FIG. 11 is a side view similar to FIG. 4 illustrating another embodiment of the transducer of the present invention.

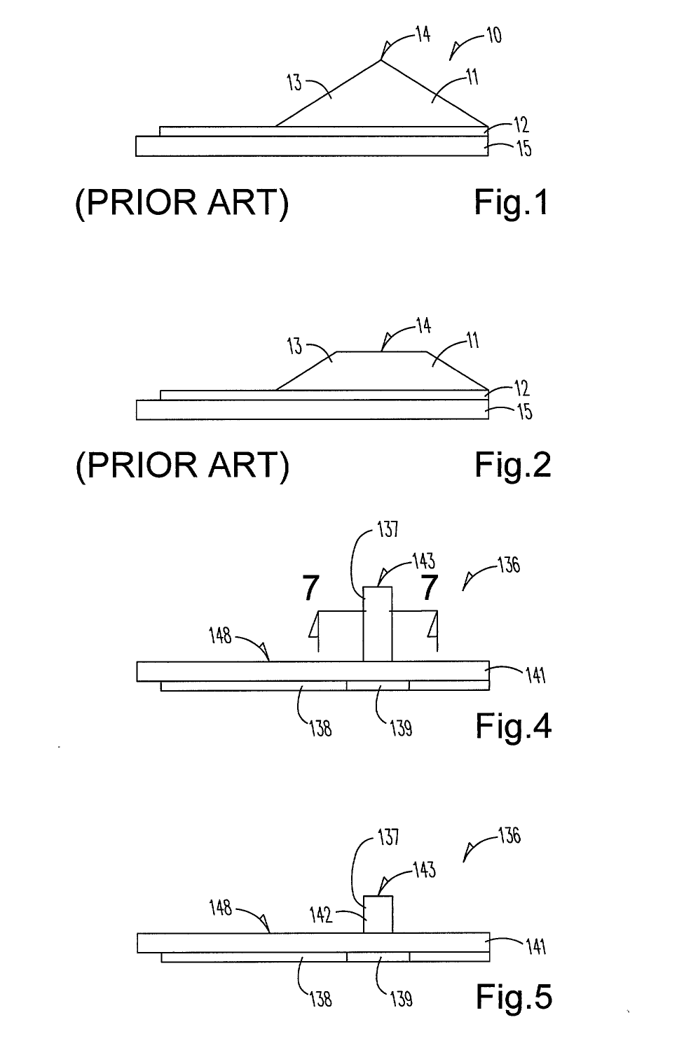

### DESCRIPTION OF THE PREFERRED EMBODIMENT

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

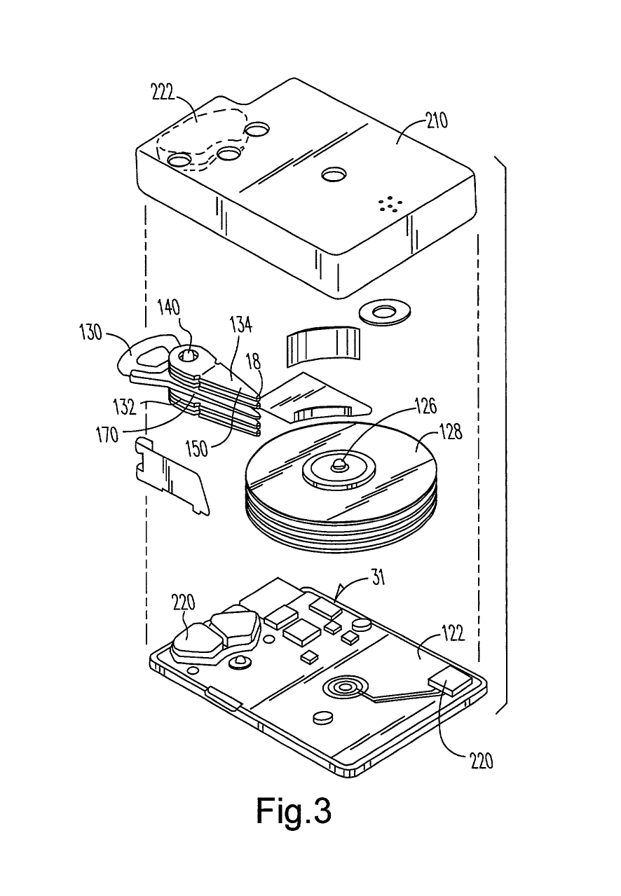

Referring to FIG. 3, the principal electrical and mechanical components of a disc drive are illustrated. The disc drive includes a head/disc assembly 120 which includes a base 122 and a cover 210. Attached to the base 122 is a spindle that includes a hub 126. The hub 126 is attached to a disc 128. A spindle motor is attached to the base 122 and rotates the spindle including the hub 126 and the disc 128. Spindle motor driver circuitry 220 controls the current passing through the spindle motor to produce an appropriate torque on the spindle. An actuator assembly 132 is also attached to the base 122. The actuator assembly 132 includes arms 134 and suspensions 150 attached to the arms 134. The suspensions 150 carry transducers 136 in a transducing relation to the disc 128. The arms 134 are attached to a pivot apparatus, such as a bearing cartridge 140. The individual transducers 136 are supported by a slider that is mounted to one of the suspensions 150. The slider carries the transducer 136 over the disc. The other end of the actuator assembly 132 includes a portion of an actuator motor 130. The portion of the actuator motor shown attached to the actuator assembly 132 is the voice coil. The actuator motor, which includes the voice coil and magnets 220 and 222 (shown in phantom), is used to move the actuator assembly 132 and, more specifically, the transducers 136 to different radial positions relative to one or more surfaces of the disc 128.

FIG. 4 illustrates one embodiment of the transducer 136 of the present invention. The transducer 136 includes a tip 137 that is mounted to a conductor 138 which supplies thermal and/or electrical energy to the tip 137 depending on the application where the transducer 136 is being used. The energy is supplied from the conductor 138 to the tip 137 through an interface 139.

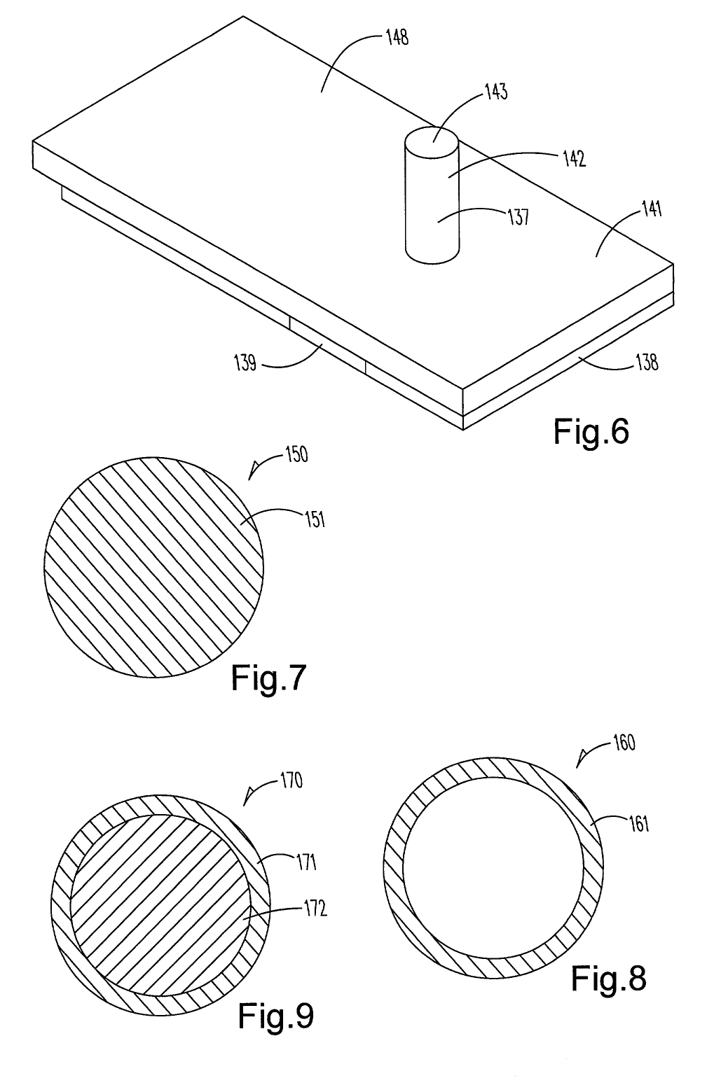

Referring now also to FIG. 6, the conductor 138 and the tip 137 are typically mounted onto a ceramic substrate, or body 141. The tip 137 extends through the body 141 and includes an exposed portion 142 that extends from the body 141. The geometry of tip 137 is such that the exposed portion 142 has a consistent cross-sectional area along at least a part of the exposed portion 142. The exposed portion 142 of the tip 137 includes an end 143. The surface area on the end 143 of the tip 137 matches the cross-sectional area on that part of the exposed portion 142 which has the consistent cross-sectional area. In a preferred embodiment, the cross-sectional area of the exposed portion 142 is constant along the entire length of the exposed portion 142.

As shown most clearly in FIG. 5, the tip 137 tends to wear during operation of the transducer 136, especially in applications where the tip 137 contacts a medium. As the tip 137 wears, the surface area on the end 143 of the tip 137 remains constant due to the shape of the exposed portion 142. Preserving the surface area on the end 143 of the tip 137 ensures a consistent and optimum transfer density over the life of the tip 137. Maintaining an optimum transfer density is desirable because the same amount of data can always be stored on the medium, or the same number of physical indentations may be made in the medium when fabricating a MEMS device.

In another embodiment, the part of the exposed portion 142 that includes a constant cross-sectional area extends from the end 143 of the exposed portion 142 such that the surface area of the end 143 remains constant as the tip 137 wears. The tip 137 preferably, although not necessarily, extends out from a surface 148 on the body 141 in a direction that is substantially perpendicular to the surface 148 on the body 141.

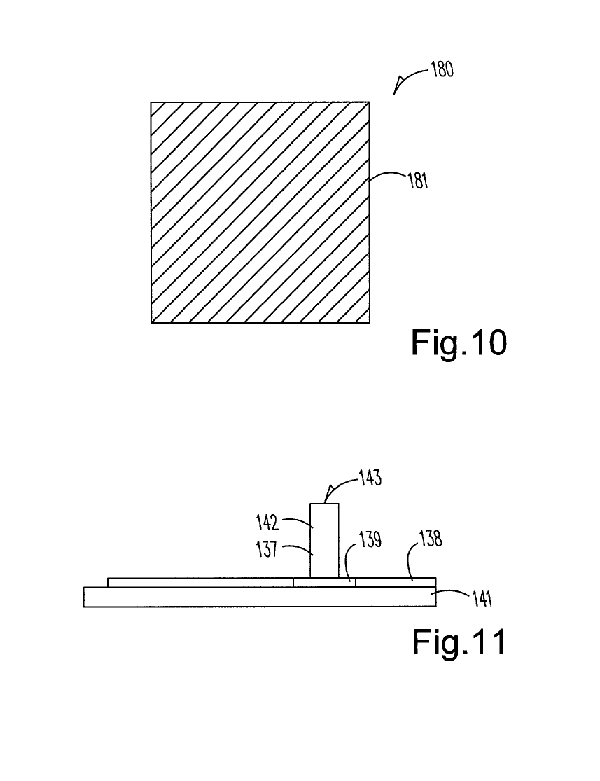

FIGS. 7-10 illustrate some of the alternative forms for tip. FIG. 7 illustrates a tip 150 with a circular cross-section 151. FIG. 8 illustrates a tip 160 with a tubular cross-section 161. FIG. 9 illustrates a composite tip 170 that includes a wear-resistant annular section 171 that is filled a magnetic material 172. The tip 170 would be especially suitable for magnetic recording applications. FIG. 10 illustrates a tip 180 with a square cross-section 181. The configuration of the tip is not limited to the forms disclosed in the drawings. The tip can be any configuration that includes a section with a constant cross-sectional area.

FIG. 11 illustrates another embodiment of the transducer 136. In this embodiment, the tip 137 extends into contact with the interface 139. The interface 139 electrically and/or thermally connects the tip 137 to the conductor 138. The conductor 138 is positioned on an opposite side of the body 141 as compared to the transducer 136 shown in FIGS. 4-6.

The transducer 136 reduces the effects of transducer wear. The optimum performance of the transducer 136 is maintained over the life of transducer 136 because the consistent cross-sectional area of the tip 137 ensures that the surface area on the end 143 of the tip 137 is preserved. In addition, the tip 137 is more likely to hold up when there is any inadvertent contact between the transducer 136 and the medium that might cause the tip 137 to fracture. Therefore, the transducer 136 is less susceptible to crashes. Any system that utilizes the transducer 136 will be more reliable and have an extended service life.

In conclusion, the present invention relates to a transducer 136. The transducer 136 includes a body 141 and a tip 137 that extends from the body 141. The tip 137 includes an exposed portion 142 that has a consistent cross-sectional area. The exposed portion 142 of the tip 137 includes an exposed end 143. The exposed portion 142 of the tip 137 with the consistent cross-sectional area extends from the exposed end 143 of the tip 137 either part of the way toward, or all of the way into, the body 141. The body 141 may be a ceramic and the tip 137 may be a tribological material. The transducer 136 may also include a conductor 138 that transfers electrical and/or thermal energy to the tip 137.

The present invention also relates to a method of translating data to and/or from a medium. The method comprises the steps of maneuvering a transducer 136 that has an exposed tip 137 with a consistent cross-sectional area to a particular location relative to the medium, and communicating with the medium using the tip 137 on the transducer 136. The step of communicating with the medium using the tip 137 on the transducer 136 may include exchanging data with the medium using the tip 137 on the transducer 136. Exchanging data with the medium may include reading and/or writing data to and/or from the medium. The step of maneuvering the transducer 136 to a particular location relative to the medium may further include contacting the tip 137 of the transducer 136 with the medium and applying heat to the medium through the transducer 136 to facilitate indenting the medium with the tip 137 of the transducer 136.

The invention generally relates to a transducer 136 that includes means for communicating with a medium in a continuous manner as the means for communicating with the medium wears. The means for communicating with the medium is supported by a body 141 of the transducer 136.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A transducer comprising:
(a) a body; and
(b) a tip extending from the body, the tip having an exposed portion with a consistent cross-sectional area.

2. The transducer of claim 1 wherein the tip includes an exposed end such that the exposed portion of the tip with the consistent cross-sectional area extends from the exposed end of the tip toward the body.

3. The transducer of claim 1 wherein the exposed portion of the tip with the consistent cross-sectional area comprises the entire tip that extends from the body.

4. The transducer of claim 1 wherein the body is a ceramic.

5. The transducer of claim 1 wherein the tip is cylindrical.

6. The transducer of claim 1 wherein the tip is tubular.

7. The transducer of claim 1 wherein the tip is a tribological material.

8. The transducer of claim 1 wherein the tip is a thermally conductive material.

9. The transducer of claim 1 further comprising a heater attached to the tip.

10. The transducer of claim 1 wherein the tip extends out from a surface on the body in a direction that is substantially perpendicular to the surface on the body.

11. A method of translating data from and/or to a medium, the method comprising the steps of:
(a) maneuvering a transducer that has an exposed tip with a consistent cross-sectional area to a particular location relative to the medium; and
(b) communicating with the medium using the tip on the transducer.

12. The method of claim 11 wherein the step of communicating with the medium using the tip on the transducer comprises exchanging data with the medium using the tip on the transducer.

13. The method of claim 12 wherein the step of exchanging data with the medium using the tip on the transducer comprises reading data from the medium.

14. The method of claim 12 wherein the step of exchanging data with the medium using the tip on the transducer comprises writing data to the medium.

15. The method of claim 11 wherein the step of maneuvering the transducer to a particular location relative to the medium comprises contacting the tip of the transducer with the medium.

16. The method of claim 15 further comprising the step of (c) applying heat to the medium using the transducer to facilitate indenting the medium with the transducer when the transducer contacts the medium.

17. The method of claim 11 wherein the step of maneuvering the transducer to a particular location relative to the medium comprises positioning the tip of the transducer in close proximity to the medium.

18. A transducer comprising:
(a) means for communicating with a medium in a continuous manner as the means for communicating with the medium wears; and
(b) a body for supporting the means for communicating with the medium.

19. The transducer of claim 18 wherein the means for communicating with the medium comprises a tip on a transducer.

20. The transducer of claim 19 wherein the tip of the transducer extends from the body, the tip having an exposed portion with a consistent cross-sectional area.
